(19) United States
(12) Patent Application Publication
(10) Pub. No.: US 2018/0360578 A1
(43) Pub. Date: Dec. 20, 2018

(54) APPARATUS AND METHOD OF AMALGAM WASTE RECOVERY

(71) Applicant: Charles McCary, HUNTSVILLLE, AL (US)

(72) Inventor: Charles McCary, HUNTSVILLLE, AL (US)

(21) Appl. No.: 15/626,153

(22) Filed: Jun. 18, 2017

(51) Int. Cl. A61C 17/06; B01D 29/31; B01D 29/58; B01D 15/08; C02F 1/28; B01D 29/76

(52) U.S. Cl. CPC A61C 17/046; B01D 29/31; B01D 29/58; C02F 2101/20; C02F 1/283; B01D 29/76; B01D 15/08

(57) ABSTRACT

The apparatus and method of amalgam waste recovery provides for the effective recovery of amalgam waste, including mercury and other toxic substances, during a dental procedure. The apparatus includes a novel filter that effectively captures waste and a recovery method that provides for the efficient recovery of mercury, gold, and silver waste during dental procedures. The filter includes a cylindrical shape that effective entraps dental waste both along the sides and upon the flat, circular end. The apparatus may be composed of cellulose or paper allowing recovery of mercury vapors and other by-products.

### (a) TITLE OF THE INVENTION

This invention is titled “Apparatus and Method of Amalgam Waste Recovery”. The inventor of the Apparatus and Method of Amalgam Waste Recovery was is Charles McCary, 2818 Talon Circle, Huntsville, Ala., US 35811. Charles McCary is a resident of the United States.

### (b) CROSS-REFERENCE TO RELATED APPLICATIONS

Not applicable.

### (c) STATEMENT REGARDING FEDERALLY SPONSORED RESEARCH OR DEVELOPMENT

Not applicable.

### (d) THE NAMES OF THE PARTIES TO A JOINT RESEARCH AGREEMENT

Not applicable.

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not applicable.

### (f) STATEMENT REGARDING PRIOR DISCLOSURES BY THE INVENTOR OR JOINT INVENTOR

The inventor did not disclosed the invention herein prior to the 12 month period preceding the filing of this non-provisional application.

### (g) BACKGROUND OF THE INVENTION

### (1) Field of the Invention

The invention generally relates to dental devices. Specifically, this invention relates to an apparatus and method of recovering amalgam waste allowing the efficient recovery of mercury, silver, copper, zinc, tin, gold, and other dental wastes. Amalgam waste may also include bone tissue, BPA resins, prophy paste, impression material, retraction cord, tissue, and cotton particles.

### (2) Description of Related Art

Amalgam is a common material used to fill dental cavities. Amalgam consists of a combination of materials including, but not limited to, silver, gold, mercury, tin, copper, and small amounts of zinc, indium or palladium may be used. During a dental procedure it often becomes necessary to remove an amalgam filling. Mercury released during amalgam removal can be hazardous. Additionally, recovery of valuable gold and silver from amalgam waste conserves these materials. Prior art devices disclose a number of devices that filter dental amalgam debris removed during dental procedures. McCary (U.S. Pat. No. 8,393,898 B2) discloses a disposable high volume evacuator (hereinafter “HVE”) tip with an integrated filter. The device of McCary is intended to be disposed after a single use and may include either a sealed housing with a preset filter to prevent spillage of waste, or an open housing that permits the enclosed filter to be changed prior to use. The device of McCary (U.S. Pat. No. 8,393,898 B2) captures debris greater than 10 microns in size. The device of McCary (U.S. Pat. No. 8,393,898 B2) has a number of significant limitations. First, the device of McCary (U.S. Pat. No. 8,393,898 B2) is not able to capture debris smaller than 10 microns. During dental procedures, mercury smaller than 10 microns may be released and collected in the water stream during suctioning of a dental patient. This hazardous mercury is released into the water effluent. Second, large debris collects at the end of the conical tip of the McCary filter (U.S. Pat. No. 8,393,898 B2) preventing the free flow of water effluent, limiting filtration capacity of the filter device. Third, it is difficult to safely retrieve gold and other materials from the plastic device of McCary (U.S. Pat. No. 8,393,898 B2) because the metal from the dental waste cannot easily be safely separated from the filter device.

The apparatus and method herein meets the challenges experienced in safely recovering amalgam waste, including mercury and certain metals, and other dental waste. The apparatus comprises a filtration unit to capture waste discharged into a stream of water while said stream of water is being suctioned from a patient's mouth. The filtration unit may include a charcoal-infused filter that enables the safe and efficient capture of mercury particles smaller than 10 microns. Additionally, a charcoal-infused filter assists in the removal of chlorine, sediment, volatile organic compounds, taste, and odor from the water being filtered. The filtration unit may be formed into a cylindrical shape such that the end of the cylindrical filter provides a large, flat surface that maximizes the filter's ability to collect waste and is less susceptible to clogging. And, the method herein provides for the safe retrieval of mercury and metal waste from water that has been suctioned from the mouth of a dental patient.

### (i) BRIEF DESCRIPTION OF THE SEVERAL VIEWS OF THE DRAWINGS

FIG. 1 depicts an exterior view of the filtration unit attached to suction tubing.

FIG. 2 depicts an exterior view of the filtration unit detached from both a high evacuation tubing and a high evacuation valve.

FIG. 3 depicts an exterior view of the filtration unit attached to high evacuation tubing, is coupled to a high evacuation valve.

FIG. 4 illustrates an angled, exploded exterior view of the filtration unit attached to suction tubing.

FIG. 5 illustrates an exploded, side view of the filtration unit attached to suction tubing.

FIG. 6 shows an exterior side view of the filtration unit attached to suction tubing.

FIG. 7 depicts an exterior, side view of the filtration unit attached to tubing.

FIGS. 8, 9, and 10 illustrate an angled top view, a top, side view, and a side view of a tapered filter that may be used in the filtration unit, respectively. FIGS. 8B and 9B depict interior, sectional views of the bottom of the tapered filter, FIG. 10B depicts an exterior bottom view.

FIG. 11 depicts an exterior angled view of the outer filter of the two-part filter assembly.

FIG. 12 illustrates an exterior angled view of the inner filter of the two-part filter assembly.

FIG. 13 illustrates an angled, exterior view of the two-part filter assembly positioned with the inner filter outside of the outer filter.

FIG. 13B depicts a sectional interior view of the bottom of the outer filter and FIG. 13C depicts a sectional interior view of the bottom of the inner filter. A side view of FIG. 13 is shown in FIG. 14.

FIG. 15 depicts an angled, exterior view of a two-part charcoal filter assembly with the inner filter positioned outside of the outer filter. FIG. 15B depicts an angled interior view and 15C depict a sectional interior view of the outer charcoal filter.

FIG. 16 depicts a side view of FIG. 15.

FIGS. 16B and 16C depict an angled interior view and a sectional interior view of the inner charcoal filter, respectively.

FIG. 17 depicts a side view of the two-part charcoal filter assembly with the inner filter protruding from the outer filter. FIG. 18 is an angled view of FIG. 17.

FIG. 19 depicts an angled, bottom view of the inner charcoal filter, while FIG. 19B depicts a sectional view of the bottom of the inner charcoal filter, while 19C depicts an angled interior view. FIG. 20 illustrates an angled, top view of FIG. 19 and FIG. 21 depicts a side view of FIG. 19.

FIG. 22 depicts an angled bottom view of the outer charcoal filter, and FIG. 22B depicts a sectional inner view of the bottom of the outer charcoal filter. FIG. 23 depicts an angled, top view of FIG. 22. FIG. 24 depicts a side view of FIG. 22. FIG. 24B depicts an angled interior view of the bottom of the outer charcoal filter.

FIGS. 25, 26, and 27 illustrate a one-stage filter that may be used alone or in combination with other filters. FIG. 27B depicts a sectional interior view of the bottom of the one-stage filter.

### (j) DETAILED DESCRIPTION OF THE INVENTION

The present invention is directed to a new apparatus and method for collecting amalgam waste and other dental waste during dental procedures. While this invention is susceptible of embodiment in many different forms, there are shown in the drawings and will herein be described in detail, several embodiments with the understanding that the present disclosure should be considered as an exemplification of the principles of the invention and is not intended to limit the invention to the embodiments so illustrated. Further, to the extent that any numerical values or other specifics of materials, etc., are provided herein, they are to be construed as exemplifications of the inventions herein, and the inventions are not to be considered as limited thereto.

The following description and drawings are illustrative and are not to be construed as limiting. Numerous specific details are described to provide a thorough understanding of the disclosure. However, in certain instances, well-known or conventional details are not described in order to avoid obscuring the description. References to one, or an, embodiment in the present disclosure can be, but are not necessarily, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, or is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the disclosure or of any exemplified embodiment. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control. Amalgam waste includes all waste suctioned from the mouth of a patient during a dental procedure and includes, but is not limited to: mercury, silver, copper, zinc, tin, gold, bone tissue, BPA resins, prophy paste, impression material, retraction cord, tissue, cotton particles, and other dental waste products. Water effluent is water that has been suctioned from the mouth of a dental patient.

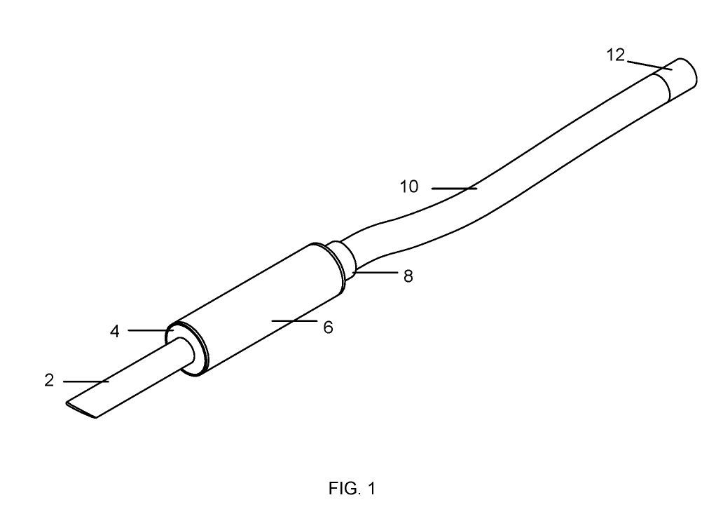

The present invention is directed to an apparatus and method of filtering amalgam and other dental waste during dental procedures. Specifically, the apparatus comprises a filtration unit and the method comprises a method of utilizing said filtration unit to recapture certain waste materials from the water effluent that has been suctioned from the mouth of a patient. FIG. 1 depicts an exterior view of the wherein housing 6 of the filtration unit is coupled to suction tube 2 via suction tube plug 4. Suction tube 2 is inserted into the mouth of a patient. Suction tube 2 is typically disposable and is only used for one patient. Housing 6 is coupled to discharge tube 10 via discharge tube plug 8. Connector 12 couples housing 6 to a vacuum source that creates suction that draws water and dental waste from a patient's mouth through the filtration unit. The vacuum/suction force travels from discharge tube 10, through housing 6, and out suction tube 2 The suction emitted from suction tube 2 pulls water and debris from a dental patient's mouth into suction tube 2, through housing 6, and through discharge tube 10. Vacuum/suction pulls water and amalgam debris from the patient's mouth through housing 6.

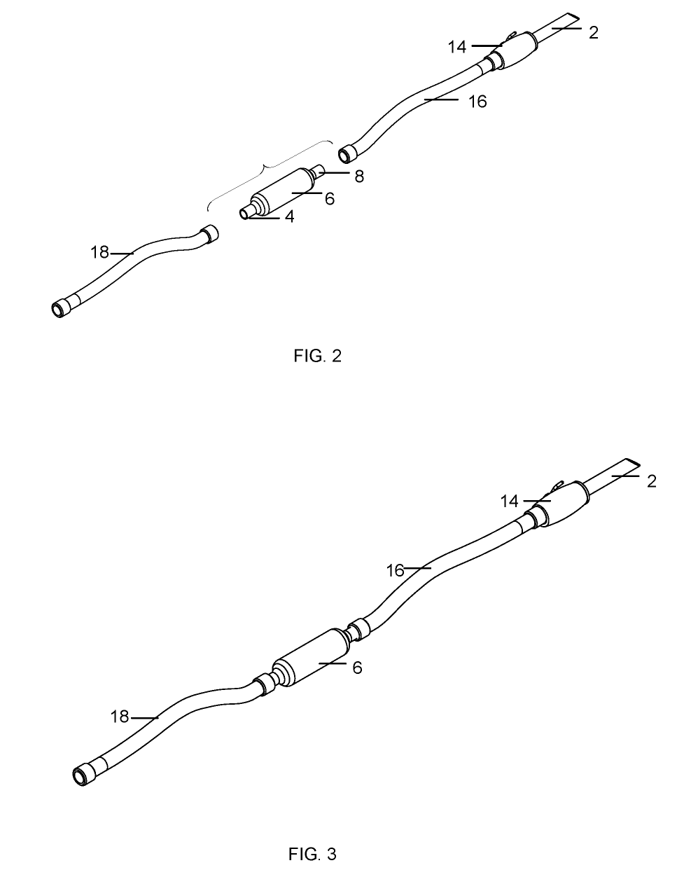

FIGS. 2 and 3 depict housing 6 of the filtration unit detached from and attached to a high evacuation system, respectively. Dental offices commonly employ high volume evacuation (hereinafter “HVE”) to suction water and debris from a patient's mouth. HVE evacuation systems typically utilize HVE tubing, such as aspesis or silcryn one-half inch tubing. Water and amalgam debris from a patient's mouth enters suction tube 2, travels through HVE valve 14 and HVE tubing 16 before reaching the filtration unit. Housing 6, suction tube plug 4, and discharge plug 8 are the parts of the filtration unit seen in FIGS. 2 and 3. Housing 6 reversibly connects to HVE tubing 16 and HVE discharge tubing 18, which allows suction tip 2 to be replaced so that a single filtration unit may be used on multiple patients.

The device herein may alternatively be utilized with a saliva ejection (hereinafter “SE”) tubing, which is typically one-fourth of an inch in diameter. In SE embodiments, valve 14 and tubing 16 are modified so that they are a quarter of an inch in diameter, instead of the one-half inch employed in HVE systems. The SE embodiment bends and hooks in the patient's mouth and is used to remove both water/moisture and prophy paste from a patient's mouth. Prophy paste fills the quarter inch vacuum line and prevents it from clogging up the half inch line used in HVE embodiments.

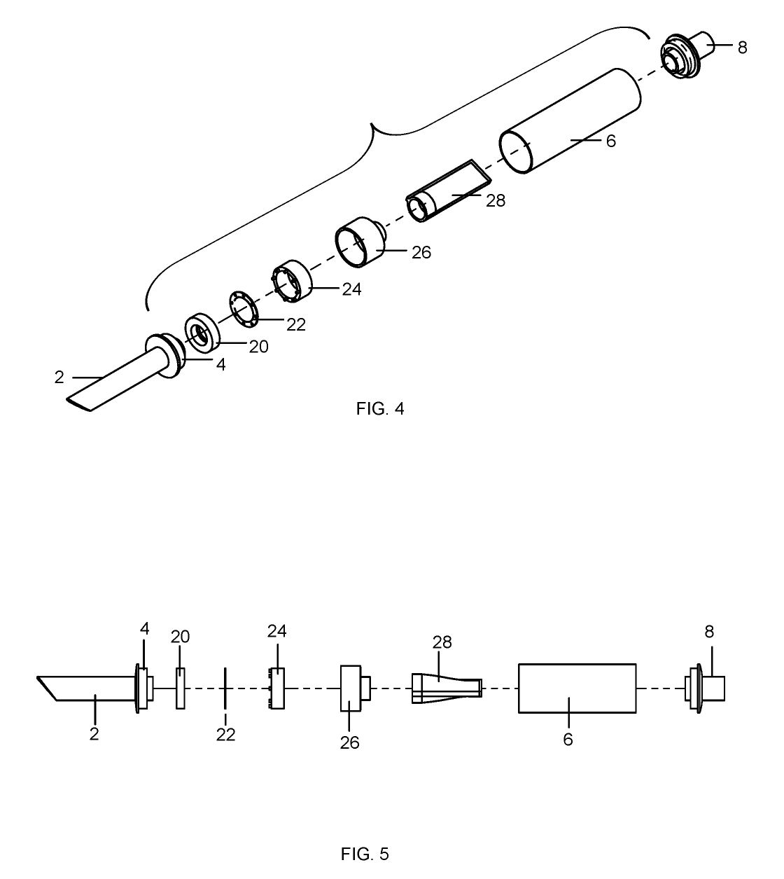

FIGS. 4 and 5 illustrate an expanded, exterior angled top view and a side view of the filtration unit, respectively. The filtration unit may include the following: suction tube plug 4, check valve assembly (composed of check valve 20, flap valve 22, check valve coupler 24), filter coupler 26, tapered filter 28, housing 6, and discharge plug 8. Suction tube plug 4 and discharge plug 8 secure the check valve assembly (composed of check valve 20, flap valve 22, check valve coupler 24), filter coupler 26, and tapered filter 28 inside housing 6. Filter coupler 26 couples housing 6 to check valve assembly (composed of check valve 20, flap valve 22, check valve coupler 24) and positions a filter within housing 6. All parts comprising the filtration unit may be composed of any suitable material that is both strong enough to withstand the suction forces exerted on the device and is sufficiently water resistant to allow housing 6 to maintain its shape. Housing 6 should have water-tight seals with both suction tube plug 4 and discharge plug 8 to maintain the integrity of the filtration unit.

In one embodiment, all parts of the filtration unit may be composed of plastic, including high density polyethylene, and silicone. Plastic is inorganic, not biodegradable, and melts when heated. Likewise, silicone is inorganic, not biodegradable, and is resistant to heat. The plastic and silicone embodiment may be opened in a controlled environment, such as a secured processing facility with the ability to handle hazardous and biological waste, and the amalgam waste recovered from filter 28. In an alternate embodiment, the filtration unit may include the following parts composed of paper or cellulose: filter 28, housing 6, and suction tube plug 4. This allows the filtration unit to be opened and the filter 28, housing 6, and suction tube plug 4 to be removed. A number of cellulose membranes are commercially available. The cellulose embodiment may be composed of Advantec A045A154D nitrocellulose membrane 0.45 μm 15×15 cm membrane with a pore size of 0.45 microns, which is produced by Cole-Parmer®. Additionally, Swift Filters, Inc.™ produces cellulose filter media with pore sizes of 5, 10, 20 and 40 microns that can withstand increased pressure. The cellulose/paper embodiment may be soaked in water allowing the paper to breakdown so that the debris separates from the filter allowing easy recovery of the amalgam debris and other dental waste. Alternately, the paper embodiment of filter 28 may be burned. Filter 28, housing 6, and suction tube plug 4 composed of paper may be burned at a suitable temperature so that the paper components are transformed ashes and smoke, allowing the silver, gold, tin, copper, zinc, indium and palladium to be fully recovered. Additionally, any mercury trapped in the paper filter 28, housing 6, and suction tube plug 4 will evaporate during burning, preventing contamination of water and landfills. Suction tip 2 may also be produced of paper further reducing the amount of unsustainable waste produced during a dental procedure. The removal of mercury from amalgam waste will allow dentists to comply with environmental regulations relating to water and air safety. And, using less plastic and silicone means less plastic and silicone disposed of in landfills.

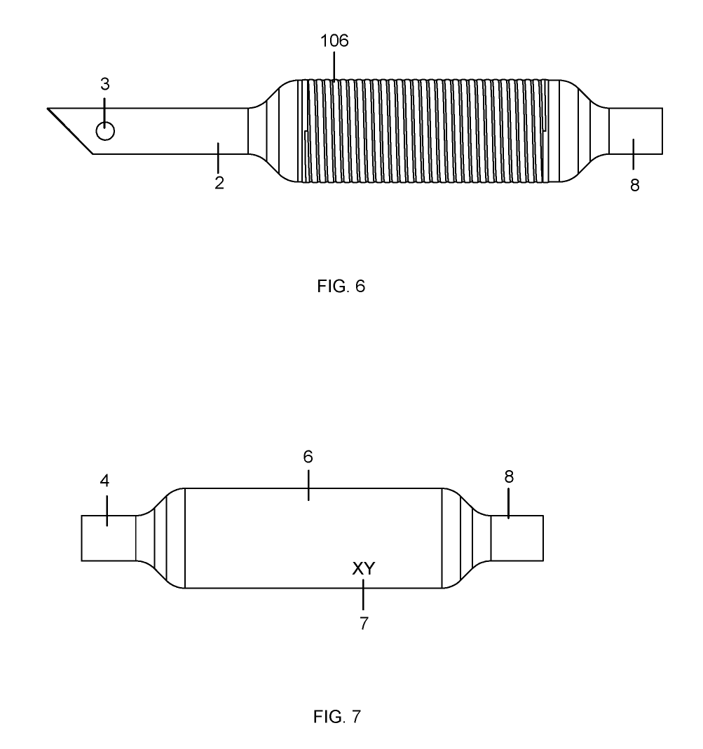

FIG. 6 depicts a side view of ribbed housing 106, discharge plug 8, and suction tip 2 wherein suction tip 2 includes suction reducer 3. Suction reducer 3 may be included to reduce the force of suction within a patient's mouth preventing irritation and damage, such as tissue grabbing. Ribbed housing 106 includes ribs or knurling to allow a dentist, dental hygienist, dental assistant, or other user to firmly grip the filtration unit even while using in wet conditions. Housing 6, which is shown in FIG. 7, may be smooth without any coating or coated with a material to promote gripping by a user. Label 7 may be included so that a unique number or character could be placed on each housing 6 unit so that individual waste can be associated with a patient to allow tracking of amalgam debris.

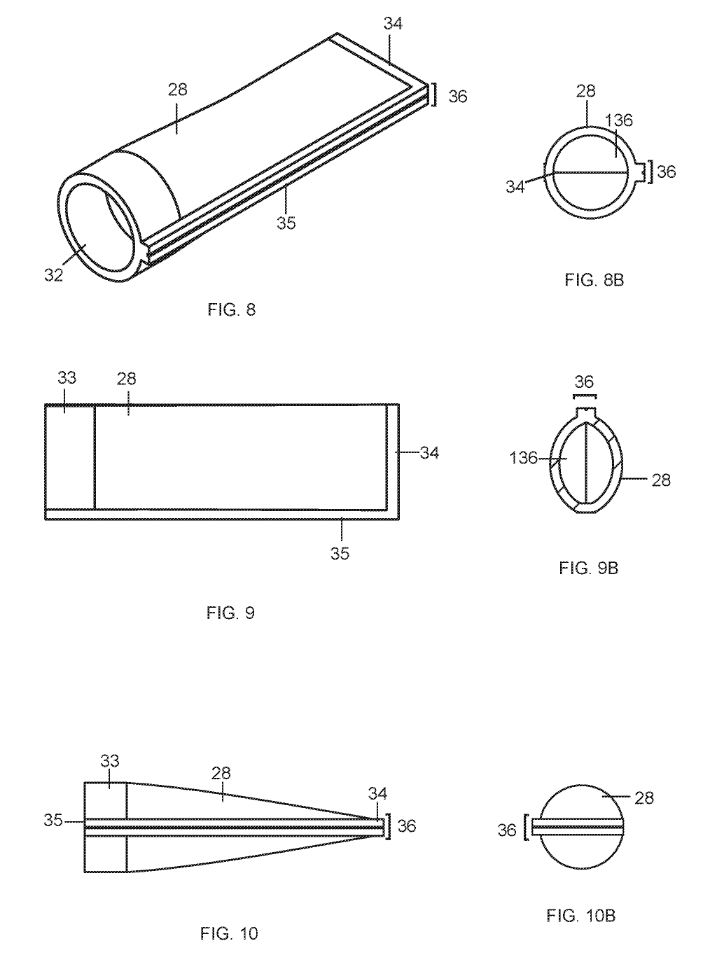

A tapered filter embodiment is depicted in FIGS. 8, 9, and 10. FIG. 8 depicts an angled top view of tapered filter 28. Tapered filter 28 may be composed of any suitable material. Tapered filter 28 includes base opening 32 that fits onto filter coupler 26. Tapered filter 28 may be sown or sealed along flat seam 34, which runs along its bottom width, and flat seam 35, which runs along its length. Tapered filter 28 includes thickness 36 that may be at least twice the thickness of tapered filter 28. FIG. 8B depicts a sectional interior view of the bottom of tapered filter 28. Flat seam 34 traverses the bottom of the filter. Tapered filter 28 forms circular-shaped bottom filtration surface 136 with thickness 36. Bottom filtration surface 136 forms a circular shape that provides a large filtration surface to capture debris. FIG. 9 depicts a top view of tapered filter 28. FIG. 9 depicts filter 28 with a width that is equivalent throughout its length. FIG. 9 depicts seam 35 that runs the length of tapered filter 28 and seam 34, which runs the width of tapered filter 28. Tapered filter 28 may include filter base 33 that supports tapered filter 28 and helps to secure said tapered filter 28 onto filter coupler 26. FIG. 10 illustrates a side view of tapered filter 28. Note that the side view shows tapered filter 28 tapering along its side. The thickness of tapered filter 28 is greatest at filter base 33 and narrows throughout its length so that the filter is at its narrowest width when it reaches seam 34. Tapered filter 28 may be composed of any suitable material that allows sufficient filtration of amalgam waste. The narrowing of the width of tapered filter 28 permits the collection of amalgam debris throughout the length of the tapered filter. Tapered filter 28 allows the accumulation of amalgam and other dental waste and debris along the full width of tapered filter 28 at seam 34. Tapered filter 28 may composed of material allowing it to capture amalgam waste and dental debris 5 microns or greater in size. FIG. 9B depicts a sectional interior view of the bottom of the tapered filter 28 formed into a circular shape via seam 34 that has a thickness of 36. FIG. 10B depicts an exterior view of the tapered filter. Filter 28 forms a circular shape with thickness 36 sealing the filtration cavity. This filter design significantly increases the surface area for filtering of waste over the prior art, which increases the amount of debris that can be filtered. This filter design also inhibits clogging of amalgam debris at seam 34, which significantly improves the filtration capacity of the filtration unit.

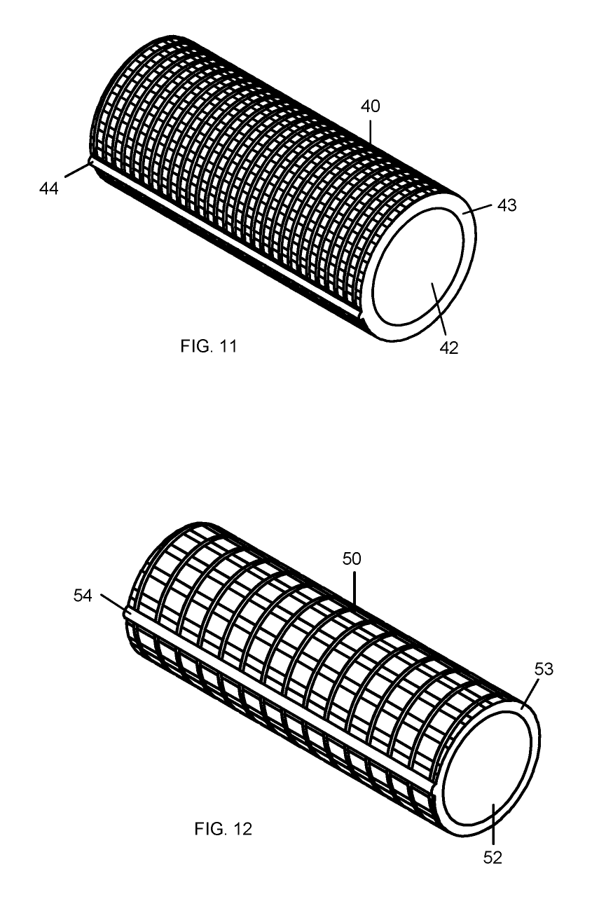

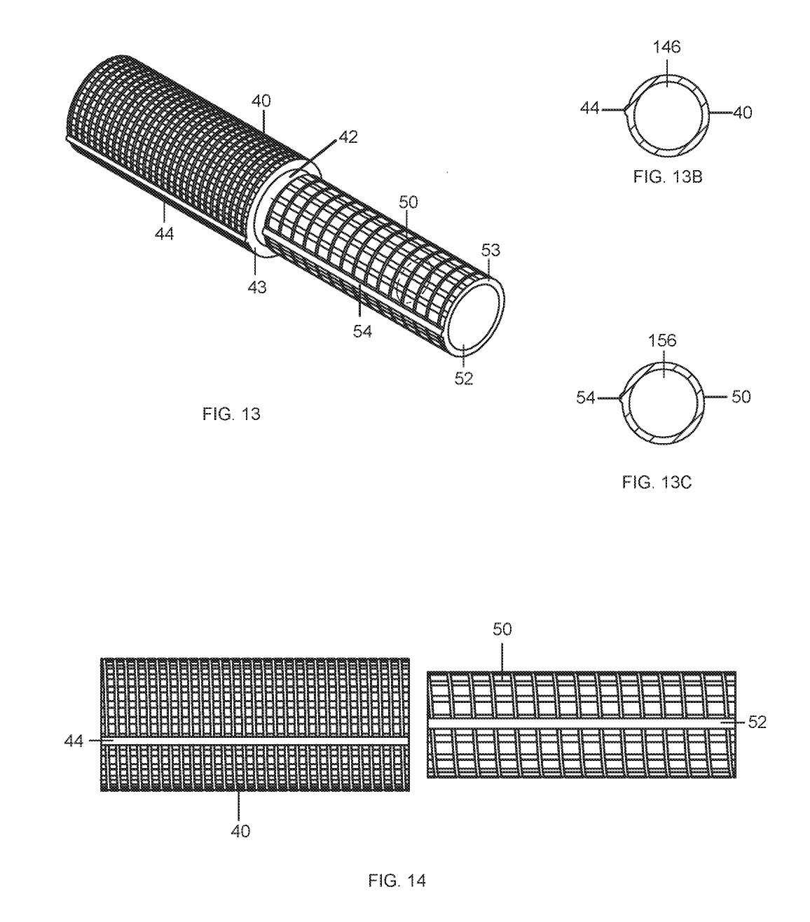

A two-stage filter assembly utilizing both a larger, outer filter and a smaller, inner filter that nests inside the outer filter is depicted in FIGS. 11 through 14. FIGS. 11 and 12 depict external, angled views of the outer filter and inner filter, respectively. FIG. 13 illustrates an external, angled view of the inner filter 50 positioned at the opening of outer filter 42, while FIG. 14 illustrates a side view of the filter assembly. Either the outer or inner filter may be utilized alone or in combination with each other. Both the outer and inner filters are cylindrical in shape. FIG. 11 shows outer filter 40 that may include opening 42, wherein the inner filter nests. Outer filter 43 has thickness 42 that allows for the filtration of amalgam waste through outer filter 40. Outer filter 40 may be composed of paper or cellulose that is heat sealed along seam 44. The composition of outer filter 40 allows the filtration of amalgam debris and other dental waste greater than 5 microns to be removed from the water effluent. Seam 44 may not be visually distinguishable to most users. FIG. 12 depicts inner filter 50 that includes opening 52 and is of thickness 53. Water suctioned through the filtration unit is forced through thickness 53 filtering out debris. Inner filter 50 may be composed of paper or cellulose that is heat sealed along seam 54. Outer filter 40 may be composed of a filter material that includes pores that allow the filtration of debris as small as 5 microns. Inner filter 50 may be composed of a filter material that includes pores that allow the filtration of debris with a size range of 10 to 30 microns. Larger debris may also be trapped by inner filter 50. Both outer filter 40 and inner filter 50 include a flat bottom (not shown) opposite opening 42 and 52, respectively. The flat, closed end shown is shown in FIGS. 13B and 13C. FIG. 13b depicts the flat, circular-shaped filtration surface 146 of outer filter 40 that provides a large surface area for entrapment of debris within outer filter 40 inhibiting clogging of the filter during the filtration process. FIG. 13C depicts the flat, circular-shaped closed end of inner filter 50. The circular-shaped filtration surface 156 provides a large surface are for entrapment of debris, which inhibits clogging of inner filter 50 during the filtration process. This two-stage filter assembly allows for the enhanced removal of amalgam debris.

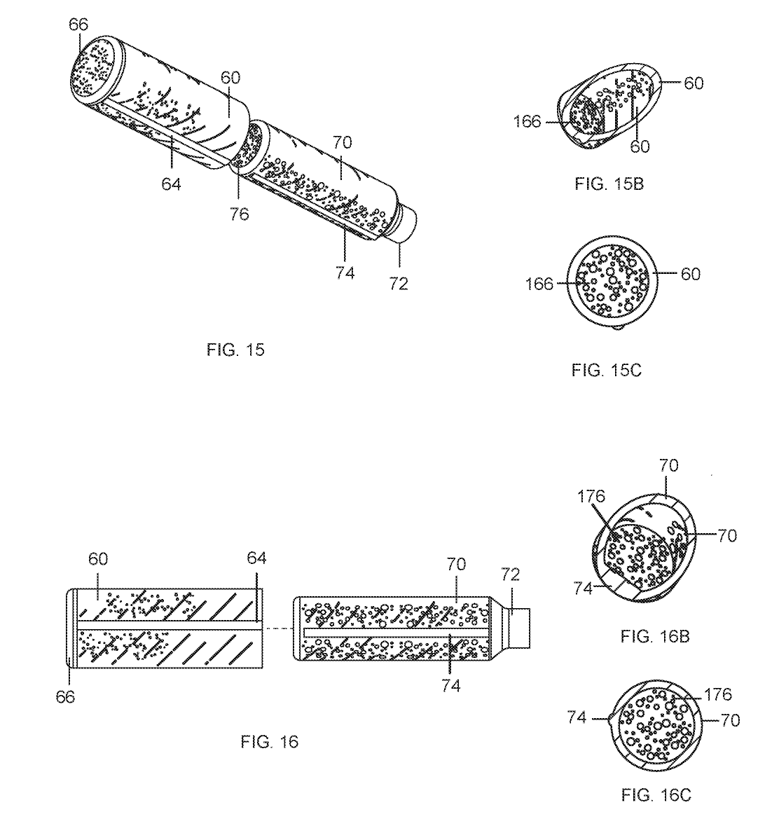

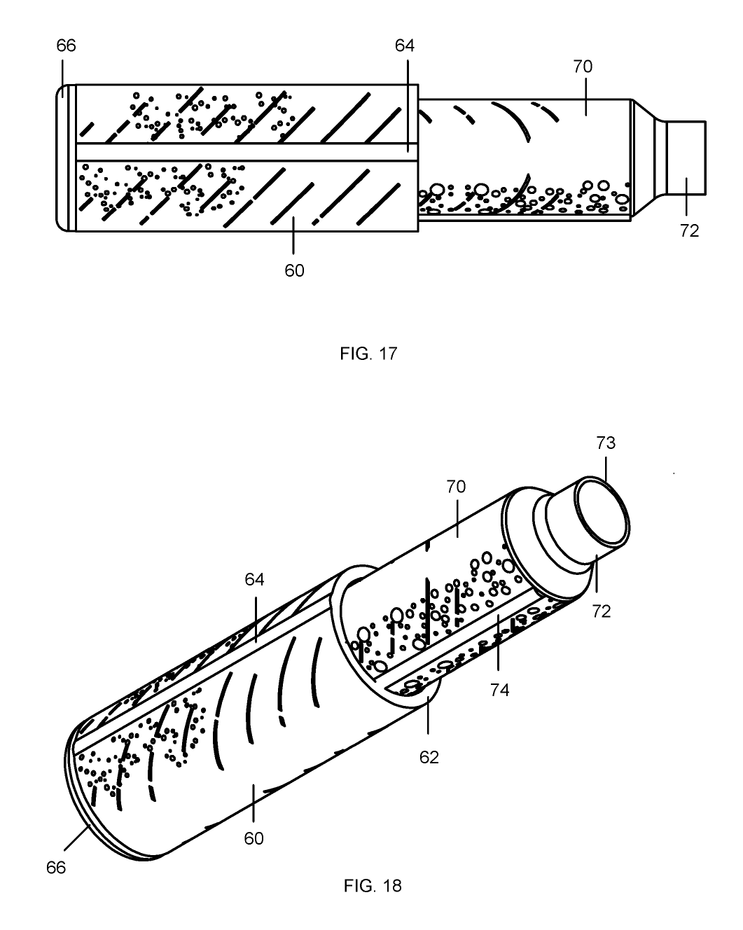

FIGS. 15 through 24 depict different views of the two-stage filter assembly with charcoal infused into the filter material. The two-stage filter assembly is shown with inner charcoal filter 70 in line with outer charcoal filter 60. FIG. 16 depicts a side view of FIG. 15. Both outer charcoal filter 60 and inner charcoal filter 70 are composed of paper or another suitable material fused at seams 64 and 74, respectively. FIGS. 15B and 15C depict inner views of outer charcoal filter 60. FIG. 15B depicts an angled view of the interior of outer charcoal filter 60. Outer circular closed end 66 forms flat filtration surface 166 on the interior of the inner charcoal filter 60. 15C depicts a view of flat, circular filtration surface 166 and a sectional view of inner charcoal filter 60. Inner charcoal filter neck 72 fits onto filter coupler 26 (shown in FIGS. 4 and 5). Both outer charcoal filter 60 and inner charcoal filter 70 are cylindrically shaped and include flat, circular closed end 66 and closed end 76 that form filtration surface 166 and 176 on the interior of each filter, respectively. FIG. 16B shows an angled, interior view of inner charcoal filter 70 while FIG. 16C shows a sectional view at the bottom of said inner charcoal filter 70. FIG. 16B depicts the flat, circular filtration surface 176 filter 70 and seam 74. FIG. 16C depicts flat filtration surface 176 at the bottom interior of inner charcoal filter 70. Filter 70 includes seam 74. Water and amalgam debris are pulled through the filter material trapping debris onto filtration surface 176 and filtration surface 166. Outer charcoal filter 60 includes pores that entrap debris as small as 5 microns. Inner charcoal filter 70 includes pores that entrap amalgam debris with a size of 10 to 30 microns. Large debris in excess of 30 microns may also be filtered by inner charcoal filter 70. The inclusion of charcoal allows the filter to capture mercury vapors that may be suctioned into the filter. Additionally, the inclusion of charcoal infusion in the filter allows for the removal of organic and biological compounds in the water effluent. The circular closed end of both outer charcoal filter 66 and inner charcoal filter 76 efficiently trap debris. The circular shape improves the filtering capacity by providing a larger filtration surface area than other disclosed methods. FIG. 17 depicts a side view of inner charcoal filter 70 positioned partially within outer charcoal filter 60. FIG. 18 shows an angled side view of FIG. 17. Both outer charcoal filter 60 and inner charcoal filter 70 may be used alone or in combination with each other.

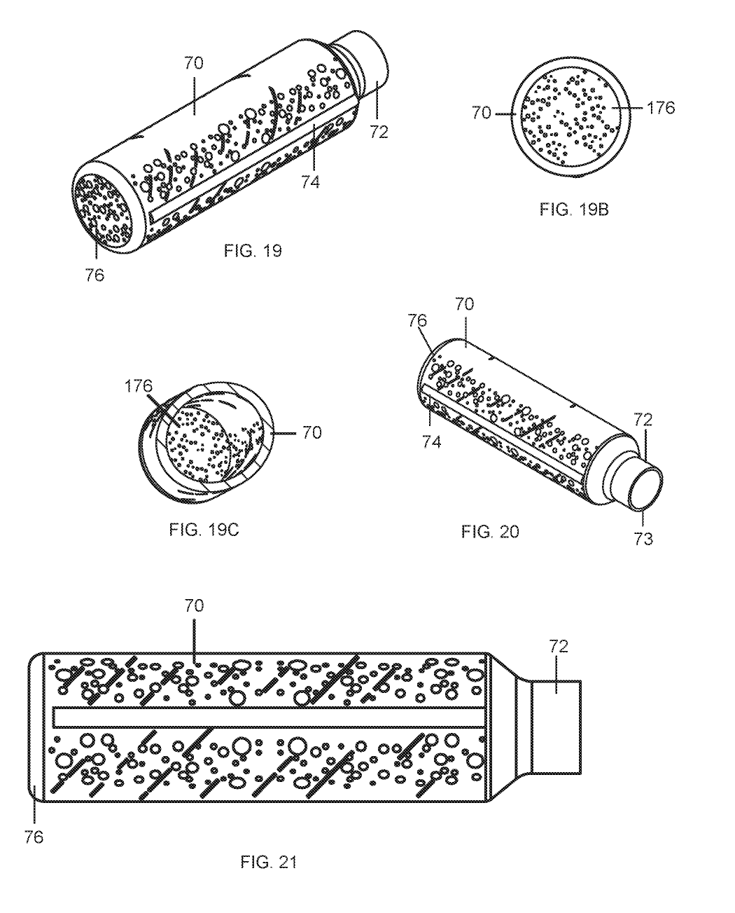

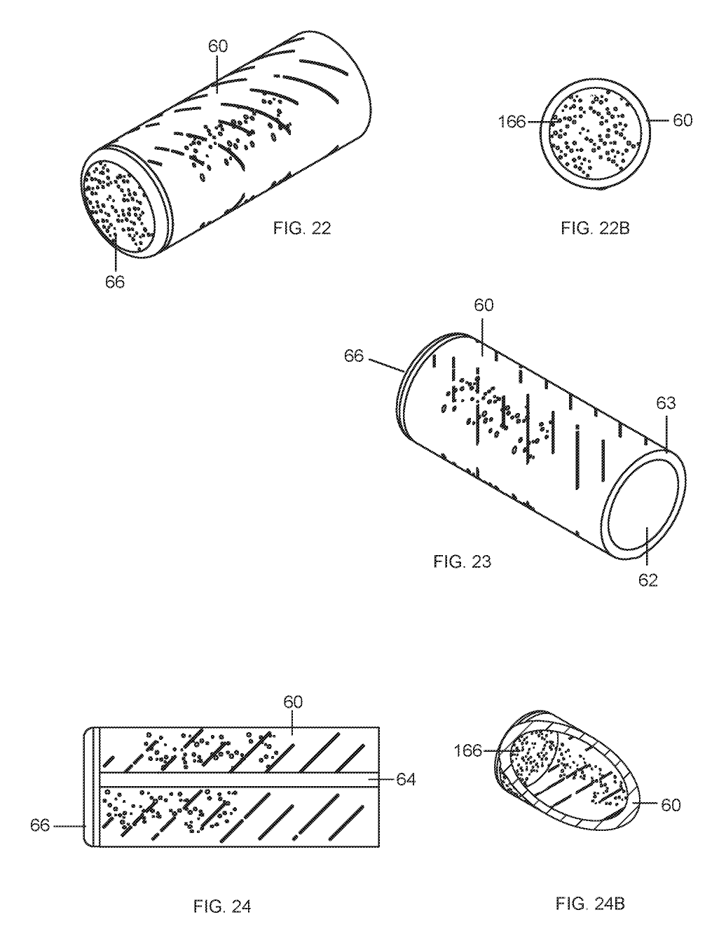

FIGS. 19, 20, and 21 illustrate an angled bottom view, an angled top view, and a side view of the inner charcoal filter, respectively. The cylindrical shape of inner charcoal filter 70 allows for the maximum entrapment of amalgam debris. The large surface area of closed end 76 creates a large filtration area on filtration surface 176 (shown in FIG. 19B) for debris capture while preventing or reducing clogging of inner charcoal filter 70, which hinders filtration. Seam 74 is sealed tightly to prevent accidental loss of amalgam waste along said seam 74. Inner charcoal filter 70 may filter amalgam and other dental waste greater a 5 microns in size. FIG. 19C depicts an angled view of inner charcoal filter 70 with flat, circular filtration surface 176 that abuts the wall of filter 70. A large amount of filtration debris may be trapped or entrapped onto filtration surface 166. FIGS. 22, 23, and 24 illustrate an angled bottom view, an angled top view, and a side view of outer charcoal filter 60, respectively. Outer charcoal filter 60 includes opening 62 that may nests within thickness 63 of the inner charcoal filter (shown in FIGS. 19, 20, and 21) or nests within another filter. Outer charcoal filter 60 may filter amalgam and other dental waste 10 or more microns in size onto filtration surface 176 (shown in FIG. 22B). Seam 64 is tight and may be formed by heat during mass production. Closed end 66 comprises a flat circular filtration surface area 166 (shown in FIG. 24B) that allows for the maximum recovery of waste without clogging of the filter. FIG. 24B depicts an angled, sectional view of inner charcoal filter 60. Filtration surface 166 forms a large, circular surface to entrap debris. The large surface area of the circular design allows for maximum filtration of debris during the filtration process.

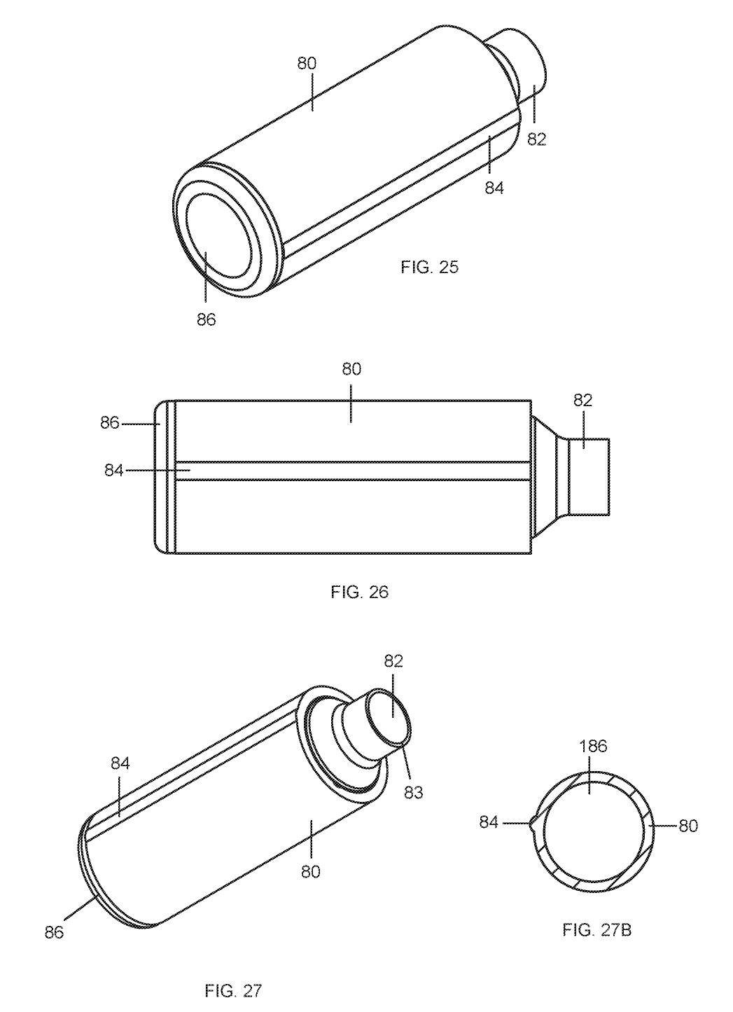

FIGS. 25, 26, and 27 illustrate a one-stage filter that may be used alone or in combination with other filters. One-stage filter 80 includes neck 82 that may be positioned upon filter coupler 26 (shown in FIGS. 4 and 5). Closed end 86 provides a flat, circular filtration surface that allows filtration of amalgam waste and other dental debris while inhibiting clogging of the filter. One-stage filter 80 may filter amalgam waste and dental debris greater than 5 microns in size. Seam 84 joins one-stage filter to form the cylindrical bag shape while preventing loss of debris. Water containing amalgam debris suctioned through the filtration unit is forced through all surfaces of one-stage filter 80 causing waste and debris to be trapped by said one-stage filter 80. One-stage filter 80 may include charcoal deposition, infusion, or other treatment. FIG. 27B depicts a sectional view of the bottom of the one-stage filter. Filtration surface 186 is a circular, flat shape that provides for maximum removal of debris during the filtration process. Water may flow through filter 80, which is sealed at seam 84, and through filtration surface 186, which forms the bottom of the one-stage filter. Additionally, one-stage filter may be coated with suitable FDA acceptable materials that prevent or inhibit bacteria growth and other microbes.

I hereby claim:

1) An apparatus for filtering dental waste from a stream of water comprising:
a filtration unit comprising:
a housing that houses a first filter,
wherein said housing comprises a first port that receives a stream of water to be filtered and a second port that is reversibly coupled to a vacuum source,
wherein said second port receives the flow of water and dental waste that has been filtered so that dental waste has been removed from said flow of water and dental waste; and
a first filter that is formed into a cylindrical shape, wherein said first filter comprises a first end that is open to receive a flow of water and dental waste entering the filtration unit through said first port, and a second end that is closed to filter dental waste from the flow of water and dental waste, wherein said second end is formed into a flat circular surface, and wherein the flow of water to be filtered flows through the flat circular surface of the first filter filtering dental waste.

2) The filtration unit of claim 1 further comprising a second filter that nests within the first filter, wherein said second filter includes a flat circular filtration surface that removes dental waste from the flow of water and dental waste, and wherein the flow of water to be filtered flows through the flat circular surface of said second filter filtering dental waste.

3) The device of claim 2, wherein the first filter removes dental waste greater than five microns in size from the flow of water and dental waste, and the second filter removes dental waste greater than ten microns in size from the flow of water and dental waste.

4) The device of claim 2, wherein the second filter is formed into a cylindrical shape with a first end that is open to receive a flow of water and dental waste that has been filtered by the first filter, and a second end that is closed, wherein said second end is formed into a flat circular filtration surface that removes dental waste from the flow of water and dental waste.

5) An apparatus for filtering dental waste from a stream of water comprising:
a filtration unit comprising:
a housing that houses a filter,
wherein said housing comprises a first port that receives a stream of water to be filtered and a second port that is reversibly coupled to a vacuum source,
wherein said second port receives the flow of water and dental waste that has been filtered so that dental waste has been removed from said flow of water and dental waste; and
wherein said filter comprises a first end that is open to receive a flow of water and dental waste entering the filtration unit through said first port, and a second end that is closed to filter dental waste from the flow of water and dental waste, wherein said filter tapers from the first end that is open to the second end that is closed, wherein said second end is formed into flat circular surface, and wherein the flow of water to be filtered flows through the flat circular surface of said filter filtering dental waste.

6) The device of claim 1, wherein the first filter includes charcoal.

7) The device of claim 2, wherein the second filter includes charcoal.

8) A method of recovering mercury vapors from a flow of water and dental waste containing mercury vapors that has been suctioned from the mouth of a person comprising:
filtering mercury vapors from said flow of water and dental waste with a filter that removes dental waste greater than five microns from said flow of water and dental waste; wherein said filter is composed of a combustible material,
burning said filter to the minimum temperature at which said filter completely burns and said mercury vapors vaporize.

9) A method of recovering metal from a flow of water and dental waste containing metal that has been auctioned from the mouth of a person comprising:
filtering metal from said flow of water and dental waste with a filter that removes dental waste greater than five microns from said flow of water and dental waste; wherein said filter is composed of a combustible material,
burning said filter to the minimum temperature at which said filter completely burns, and
recovering said metal.

10) A method of recovering metal from a flow of water and dental waste containing metal that has been suctioned from the mouth of a person comprising:
filtering metal from said flow of water and dental waste with a filter that removes dental waste greater than five microns from said flow of water and dental waste; wherein said filter is composed of a biodegradable material,
soaking said filter in a volume of water until said filter completely decomposes, and
recovering said metal from said volume of water.

11) The filter of claim 1, 2, or 5 composed of cellulose.

12) The filter of claim 1, 2, or 5 composed of paper.

13) The housing of claim 1, wherein said housing includes markings to associate said filtration unit with the mouth of a specific person.

14) The housing of claim 1, further comprising external ridges that form a gripping means.

15) The device of claim 1, wherein the second port attaches to vacuum tubing.
